(19) United States
(12) Patent Application Publication
(10) Pub. No.: US 2024/0397449 A1
(43) Pub. Date: Nov. 28, 2024

(54) P-MPR REPORTING IN A PHR MAC-CE

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/695,789

(22) PCT Filed: Nov. 10, 2021
(86) PCT No.: PCT/CN2021/129707

§ 371 Date: Mar. 26, 2024

(51) Int. Cl. H04W 52/36; H04B 17/318; H04L 5/00; H04W 56/00; H04W 80/02

(52) U.S. Cl. CPC H04W 52/367; H04B 17/328; H04L 5/001; H04W 52/365; H04W 56/0015; H04W 80/02

(57) ABSTRACT

Aspects present herein relate to methods and devices for wireless communication including an apparatus, e.g., a UE and/or a base station. The apparatus may detect an MPE event for at least one CC or at least one panel of the at least one CC. The apparatus may also configure a MAC-CE based on the MPE event, the MAC-CE including a plurality of octets and at least one IE, such that each of the at least one IE includes at least one of the plurality of octets. Additionally, the apparatus may transmit, to a base station, the MAC-CE including the plurality of octets and the at least one IE.

### CROSS-REFERENCE TO RELATED APPLICATIONS

This application for Patent is a 371 of international Patent Application PCT/CN2021/129707, filed Nov. 10, 2021, which is hereby incorporated by referenced in its entirety and for all purposes.

### TECHNICAL FIELD

The present disclosure relates generally to communication systems, and more particularly, to power headroom (PH) reporting in wireless communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may detect a maximum permissible exposure (MPE) event for at least one component carrier (CC) or at least one panel of the at least one CC. The apparatus may also reduce an output power of the UE based on the detected MPE event for the at least one CC or the at least one panel of the at least one CC. Additionally, the apparatus may transmit, to the base station, an indication of the reduced output power of the UE based on the detected MPE event. The apparatus may also configure a medium access control (MAC) control element (MAC-CE) based on the MPE event, the MAC-CE including a plurality of octets and at least one information element (IE), such that each of the at least one IE includes at least one of the plurality of octets. Further, the apparatus may identify whether the at least one IE includes a second IE, where the at least one IE includes a first IE. The apparatus may also select at least one candidate beam for a transmission of the MAC-CE. Also, the apparatus may transmit, to the base station, an indication of the at least one candidate beam for the transmission of the MAC-CE. The apparatus may also transmit, to a base station, the MAC-CE including the plurality of octets and the at least one IE.

In another aspect of the disclosure, a method, a computer-readable medium, and an apparatus are provided. The apparatus may be a base station. The apparatus may receive, from a UE, an indication of an output power reduction of the UE based on an MPE event. The apparatus may also receive, from the UE, an indication of at least one candidate beam for a transmission of a MAC-CE based on an MPE event. Moreover, the apparatus may receive, from a user equipment (UE), a medium access control (MAC) control element (MAC-CE) including a plurality of octets and at least one information element (IE), the MAC-CE being based on a maximum permissible exposure (MPE) event for at least one component carrier (CC) or at least one panel of the at least one CC. The apparatus may also configure a transmission schedule for communication with the UE based on the MAC-CE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating example communication between a UE and a base station.

FIG. 4B is a diagram illustrating example communication between a UE and a base station.

FIG. 4C is a diagram illustrating example communication between a UE and a base station.

FIG. 5A is a diagram illustrating an example bitmap for wireless communication.

FIG. 5B is a diagram illustrating an example bitmap for wireless communication.

FIG. 6 is a diagram illustrating an example MAC-CE.

FIG. 7 is a diagram illustrating an example MAC-CE.

FIG. 8 is a diagram illustrating an example MAC-CE.

FIG. 9 is a diagram illustrating example communication between a UE and a base station.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus.

FIG. 15 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

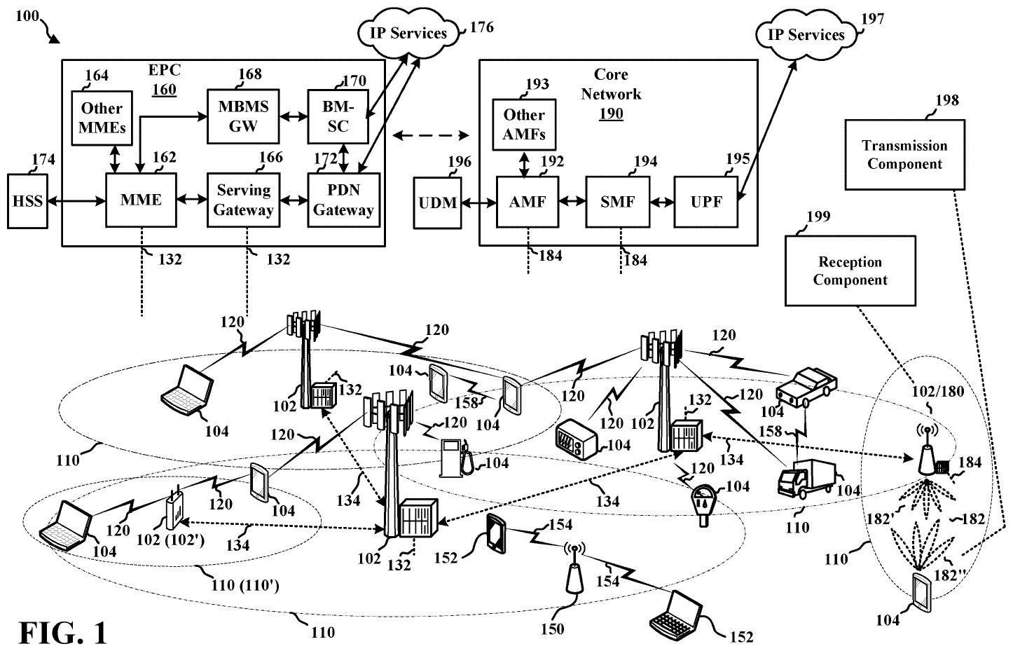

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5GNR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5GNR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a transmission component 198 configured to detect a maximum permissible exposure (MPE) event for at least one component carrier (CC) or at least one panel of the at least one CC. Transmission component 198 may also be configured to reduce an output power of the UE based on the detected MPE event for the at least one CC or the at least one panel of the at least one CC. Transmission component 198 may also be configured to transmit, to the base station, an indication of the reduced output power of the UE based on the detected MPE event. Transmission component 198 may also be configured to configure a medium access control (MAC) control element (MAC-CE) based on the MPE event, the MAC-CE including a plurality of octets and at least one information element (IE), such that each of the at least one IE includes at least one of the plurality of octets. Transmission component 198 may also be configured to identify whether the at least one IE includes a second IE, where the at least one IE includes a first IE. Transmission component 198 may also be configured to select at least one candidate beam for a transmission of the MAC-CE. Transmission component 198 may also be configured to transmit, to the base station, an indication of the at least one candidate beam for the transmission of the MAC-CE. Transmission component 198 may also be configured to transmit, to a base station, the MAC-CE including the plurality of octets and the at least one IE.

Referring again to FIG. 1, in certain aspects, the base station 180 may include a reception component 199 configured to receive, from a UE, an indication of an output power reduction of the UE based on an MPE event. Reception component 199 may also be configured to receive, from the UE, an indication of at least one candidate beam for a transmission of a MAC-CE based on an MPE event. Reception component 199 may also be configured to receive, from a user equipment (UE), a medium access control (MAC) control element (MAC-CE) including a plurality of octets and at least one information element (IE), the MAC-CE being based on a maximum permissible exposure (MPE) event for at least one component carrier (CC) or at least one panel of the at least one CC. Reception component 199 may also be configured to configure a transmission schedule for communication with the UE based on the MAC-CE.

Although the following description may be focused on 5G NR, the concepts described herein may be applicable to other similar areas, such as LTE, LTE-A, CDMA, GSM, and other wireless technologies.

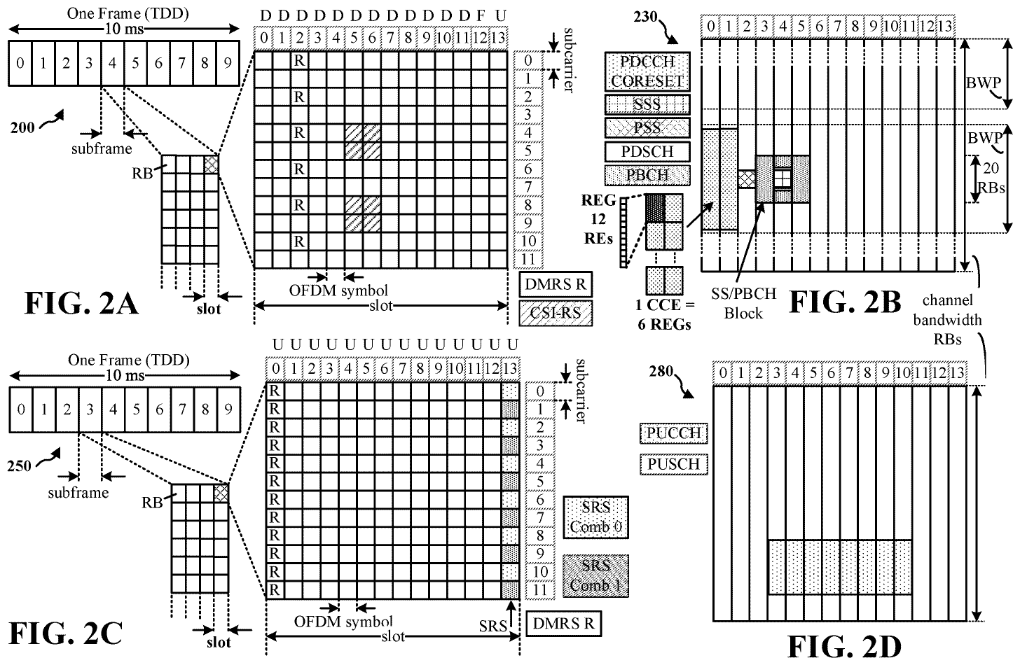

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

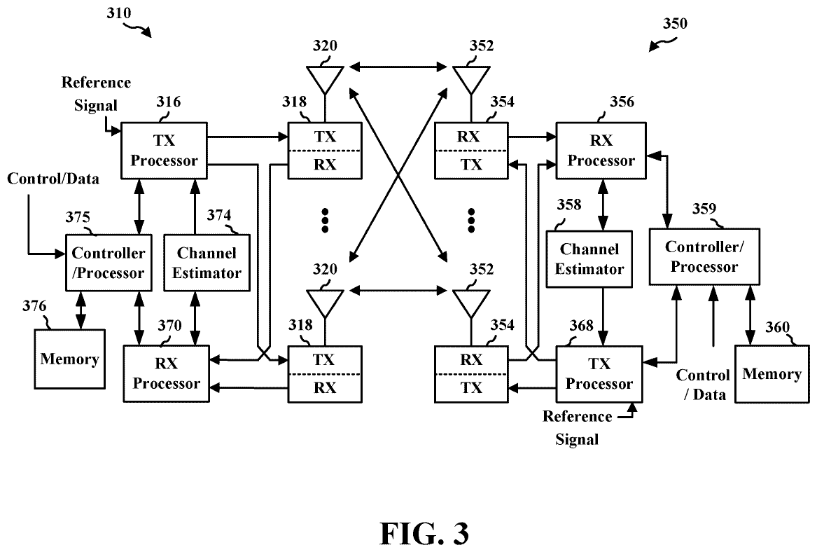

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

In wireless communications, maximum permissible exposure (MPE) is a regulation to limit the amount of maximum transmission power in the direct path of a human body. For instance, if a human body is in the direct path of a transmitted beam, this may trigger the detection of an MPE event. In some aspects, a UE may perform transmission (Tx) capping when detecting an MPE event. Based on the MPE event, depending on the distance between the transmitting device and the user or human body, the amount of Tx capping may be different. For example, if the distance between the human body and the transmitting device, e.g., a UE, is close, the Tx may be capped at one amount, e.g., 8 dBm. Also, if the distance between the human body and the transmitting device is farther, the Tx may be capped at a higher amount, e.g., 34 dBm.

For some detected MPE events, downlink transmissions may be acceptable, as the human body may be far away from the transmitting device, e.g., a base station. However, for these same detected MPE events, uplink transmissions may not be acceptable, as the human body is closer to the transmitting device, e.g., a UE. As such, the uplink transmissions that correspond to MPE events may need an alternative uplink beam to ensure that the uplink transmissions are successfully transmitted.

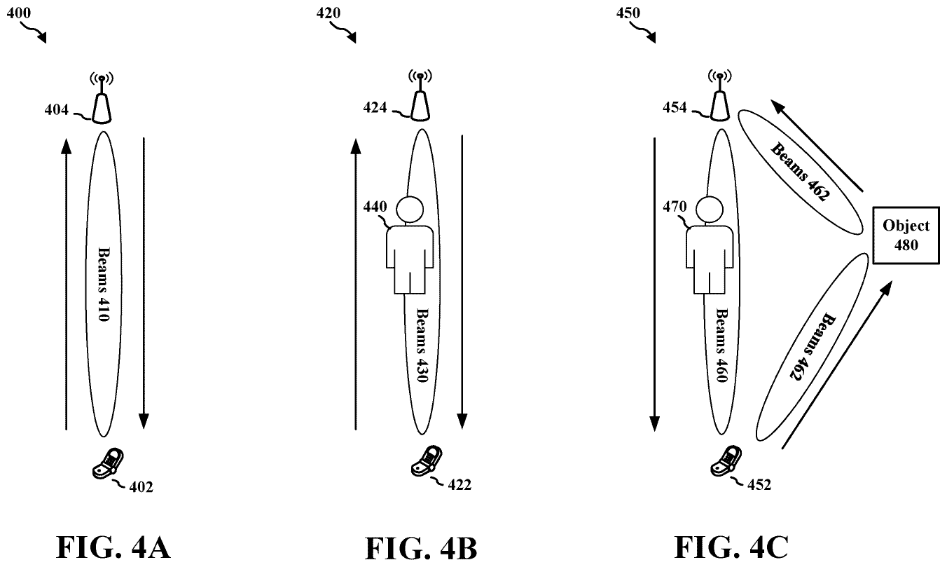

FIGS. 4A, 4B, and 4C are diagrams 400, 420, and 450, respectively, illustrating example communication between a UE and a base station. As shown in FIG. 4A, diagram 400 includes UE 402 transmitting and/or receiving one or more beams, e.g., beams 410, with base station 404. In the scenario in FIG. 4A, both uplink (UL) and downlink (DL) transmissions may be acceptable, as there is no MPE event detected. As shown in FIG. 4B, diagram 420 includes UE 422 transmitting and/or receiving one or more beams, e.g., beams 430, with base station 424. In the scenario in FIG. 4B, based on the MPE event detected due to human body 440, downlink transmissions may be acceptable, but uplink transmissions may not be acceptable. As shown in FIG. 4C, diagram 450 includes UE 452 transmitting and/or receiving one or more beams, e.g., beams 460 and 462, with base station 454. In the scenario in FIG. 4C, based on the MPE event detected due to human body 470, downlink transmissions may be acceptable, but direct uplink transmissions may not be acceptable. Accordingly, the uplink transmissions may be altered to reflect off of object 480 in order to avoid human body 470.

Aspects of wireless communication may include MPE mitigation information that may be transmitted from a UE to a base station. UEs may also investigate MPE mitigation information and specify the corresponding information in a report that is transmitted to a base station. For example, a UE may report a power management maximum power reduction (P-MPR) report. In some aspects, it may be beneficial for the P-MPR report to include a panel level and/or a beam level. Additionally, it may be beneficial for the P-MPR report to include a maximum reported number of panels, e.g., a single panel or multiple panels.

Moreover, when reporting MPE mitigation information, a UE may report a synchronization signal block (SSB) resource indicator (SSBRI), a channel state information reference signal (CSI-RS) resource indicator (CRI) and/or an indication of panel selection. The indication of panel selection may indicate alternative UE panel(s) or transmission (Tx) beam(s) for uplink (UL) transmissions. Also, the indication of panel selection may indicate a feasible UE panel(s) or Tx beam(s) for UL transmissions, which may take the MPE effect into account. There may also be an indication of panel selection details, e.g., an explicit indication or an implicit indication for the panel selection details.

In some instances, to facilitate MPE mitigation, aspects of wireless communication may include event-triggered P-MPR-based reporting (e.g., included in a PHR report when a threshold is reached, and reported via a medium access control (MAC) control element (MAC-CE)). For instance, in addition to an existing field in a PHR MAC-CE, P-MPR values may be reported (e.g., P-MPR values when N is greater than or equal to 1). Moreover, a certain number of P-MPR values (e.g., N P-MPR values) may be reported together in a PHR report. For example, for each P-MPR value, up to a certain amount of SSBRI(s)/CRI(s) (e.g., M SSBRI(s)/CRI(s)) may be reported with the P-MPR values. Also, the SSBRI(s)/CRI(s) may be selected by the UE from a candidate SSB/CSI-RS resource pool, e.g., the number of SSBRI(s)/CRI(s), M, may be equal to 1.

In aspects of wireless communications, cell-specific MPR values may be applied in configured transmit power. In some instances, the UE may configure its maximum output power. The configured UE maximum output power (P_{CMAX,f,c}) for a carrier f of a serving cell c may be defined as that available to the reference point of a given transmitter branch that corresponds to the reference point of the higher layer filtered RSRP measurement. Also, the configured UE maximum output power (P_{CMAX,f,c}) for a carrier f of a serving cell c may be set such that the corresponding measured peak equivalent isotropic radiated power (EIRP) P_{UMAX,f,c} may be within some bounds. For example, P_{UMAX,f,c} may be within: P_{Powerclass}+DP_{IBE}−max(max(MPR_{f,c}, A-MPR_{f,c},)+ΔMB_{P,n}, P-MPR_{f,c})−max{T(max(MPR_{f,c}, A-MPR_{f,c},)), T(P-MPR)}≤P_{UMAX,f,c}≤EIRPₘₐₓ, where P_{Powerclass} is the UE power class, ΔMB_{P,n} is the peak EIRP relaxation, TRPₘₐₓ is the maximum TRP for the UE power class, and P-MPR_{f,c} is the power management maximum output power reduction. This may occur while the corresponding measured total radiated power P_{TMAX,f,c} is bounded by P_{TMAX,f,c}≤TRPₘₐₓ. Also, the UE may apply P-MPR_{f,c} for carrier f of serving cell c for a number of cases. In some instances, for UE conformance testing, P-MPR_{f,c} may be equal to 0 dB.

Aspects of wireless communication may include a single panel power headroom report (PHR) that may be transmitted from a UE to a base station. Some aspects of wireless communication include single cell PHR reporting, which may include reporting MPE events. In single cell PHR reporting, ‘R’ may be a reserved bit and can be set to a certain value, e.g., a value of 0. The power headroom (PH) field ‘PH’ may indicate the power headroom level. If an MPE reporting parameter (e.g., mpe-Reporting) is configured, a ‘P’ bit may be set to a value of 0 if the power backoff is less than a threshold, e.g., P_MPR_0. Also, if the MPE reporting parameter (e.g., mpe-Reporting) is configured, the ‘P’ bit may be set to a value of 1 if the power backoff is greater than or equal to a threshold, e.g., P_MPR_0. If the MPE reporting parameter (e.g., mpe-Reporting) is not configured, a ‘P’ bit may be set to a value of 1 if the corresponding P_{CMAX,f,c} field may have had a different value if no power backoff due to power management had been applied. If the ‘P’ bit is set to a value of 0, the MPE value may not be reported. If the ‘P’ bit is set to a value of 1, the MPE value may be reported.

The maximum transmit power (P_{CMAX,f,c}) field indicates the P_{CMAX,f,c} used for the calculation of a preceding PH field. In some aspects, if the MPE reporting parameter (mpe-Reporting) is not configured, the ‘P’ bit may be set to a value of 1 if the corresponding P_{CMAX,f,c} field has a different value if no power backoff is applied, e.g., due to power management. Additionally, if mpe-Reporting is configured and the ‘P’ field is set to 1, the MPE field may indicate the applied power backoff to meet MPE specifications. The MPE field may indicate an index of the corresponding measured values of power management maximum power reduction (P-MPR) levels in dB if mpe-Reporting is configured or if the P field is set to a value of 1, and otherwise R bits are present. In some aspects of wireless communication, in multi-cell PHR reporting, the ‘Ci’ field may be the serving cell index. Also, the ‘V’ field may indicate whether the PH value is based on a real transmission (e.g., V=0) or a reference format (e.g., V=1). For a virtual PHR based on a reference format, P_{CMAX} may not be reported. Accordingly, if V is set to a value of 1, then P_{CMAX} may not be reported.

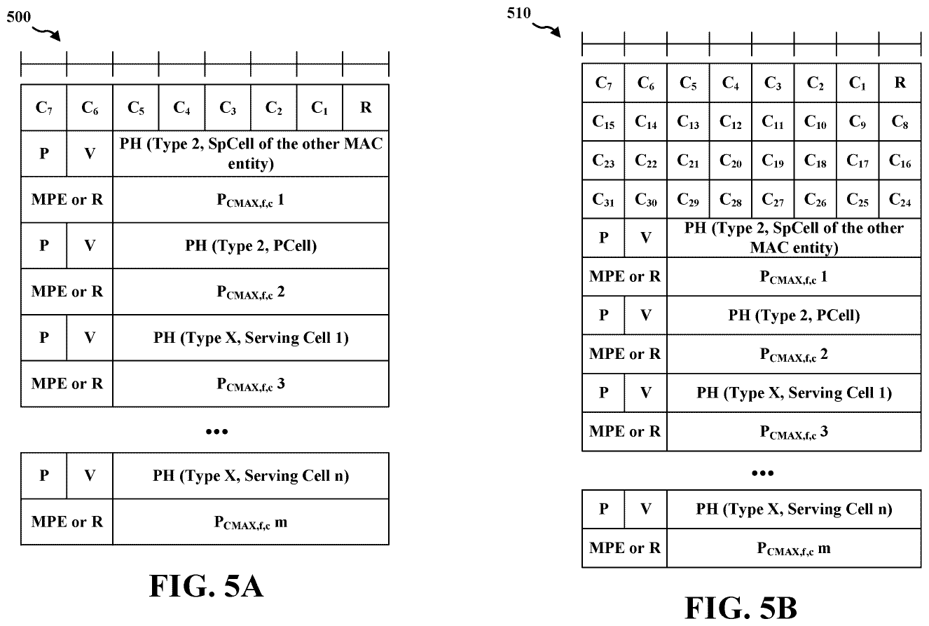

FIGS. 5A and 5B are diagrams 500 and 510, respectively, illustrating example bitmaps for wireless communication. More specifically, FIGS. 5A and 5B illustrate bitmaps for multi-cell PHR reporting. As shown in FIGS. 5A and 5B, there are multiple bitmap entries, and each entry may correspond to a single cell. Each bit in the bitmap may represent a cell index, such that there is PHR reporting for the cell. FIG. 5A shows that diagram 500 includes eight (8) entries in each row, where each row may be referred to as an octet (Oct). Also, each bit in the first row may correspond to a serving cell index. As shown in FIG. 5A, C₀ to C₇ are in the first octet (Oct) for up to 8 serving cells configured for the UE, where the C₀ bit corresponds to a reserved bit ‘R’. FIG. 5A also includes multiple entries for: a P field, a V field, a PH field, a P_{CMAX,f,c} field, and an MPE or R field.

FIG. 5B shows that diagram 510 includes eight (8) entries in each row, where each row may be referred to as an octet (Oct). Also, each bit in the first four rows may correspond to a serving cell index, which corresponds to 32 bits. As shown in FIG. 5B, C₀ to C₃₁ are in the first four octets (Oct), where the C₀ bit corresponds to a reserved bit ‘R’. Additionally, FIG. 5B includes multiple entries for: a P field, a V field, a PH field, a P_{CMAX,f,c} field, and an MPE or R field.

As indicated herein, some types of wireless communication may utilize inefficient PHR reporting, such as reporting via a PHR MAC-CE. As such, it may be beneficial to determine whether multiple information elements (IEs) may be reported in PHR reporting. Further, it may be beneficial to determine how to select a resource to be reported in PHR reporting. Additionally, it may be beneficial to determine how to report a resource index in PHR reporting.

Aspects of the present disclosure may more efficiently utilize PHR reporting, such as reporting via a PHR MAC-CE. For instance, aspects of the present disclosure may determine whether multiple IEs (e.g., a first IE (IE1) and a second IE (IE2)) may be reported in PHR reporting, such as reporting via a PHR MAC-CE. Also, aspects of the present disclosure may determine how to select a resource to be reported in PHR reporting, such as reporting via a PHR MAC-CE. Moreover, aspects of the present disclosure may determine how to report a resource index in PHR reporting, such as reporting via a PHR MAC-CE.

In some instances, for a component carrier (CC) or a panel of a CC, aspects of the present disclosure may detect an MPE event. For a CC or a panel of a CC, aspects of the present disclosure may also include at least one IE in a MAC-CE, e.g., a PHR MAC-CE. Additionally, for a CC or a panel of a CC, aspects of the present disclosure may identify whether a second IE (IE2) may be included in the at least one IE (e.g., with the first IE (IE1)). Further, for a CC or a panel of a CC, aspects of the present disclosure may identify how a resource is selected in PHR reporting. Also, for a CC or a panel of a CC, aspects of the present disclosure may identify how a resource index is reported in PHR reporting.

In some aspects, for MPE mitigation, aspects of the present disclosure may support UEs indicating in a PHR MAC-CE an activated CC or each activated panel of each CC. For a reported information or field, aspects of the present disclosure may include an IE (e.g., IE1) in an existing field in a PHR MAC-CE. The existing field in the PHR MAC-CE may include a power headroom (PH) value, a P value, a V value (where the V field may indicate whether the PH value is based on a real transmission or a reference format), a P-MPR value, and if reported, a P_{CMAX} value. For a reported information or field, aspects of the present disclosure may include an IE (e.g., IE2) for up to N P-MPR values, where the value of N may be based on configurations or a UE capability. In addition to each reported P-MPR value, one resource index may be reported.

For resource index reporting, aspects of the present disclosure may report a local index from a candidate SSB/CSI-RS resource pool. The bitwidth of the resource index may be determined by a maximum pool size, e.g., 4 bits may correspond to a maximum size of 16. Additionally, for resource index reporting, a bit in the bitmap may be reported from a candidate SSB/CSI-RS resource pool. The bitwidth of bitmap may be determined by the maximum pool size, e.g., 4 bits may correspond to a maximum size of 4. Further, aspects of the present disclosure may report a global resource index, such as a SSBRI or CRI ID. There may be one dedicated bit to differentiate that the resource is a SSB index or a CSI-RS index. The bitwidth of resource index may be determined by the maximum number of CSI-RS or SSB resources. Moreover, the global resource index may be suitable if the candidate SSB/CSI-RS resource pool is not explicitly configured.

Aspects of the present disclosure may also clarify whether a certain IE (e.g., a second IE (IE2)) may be reported in a PHR MAC-CE. In some instances, in PHR MAC-CE reporting for a CC with a detected MPE, a UE may report a certain IE (e.g., IE2). This certain IE (e.g., IE2) may be reported when another IE (e.g., IE1) indicates the presence of the certain IE (e.g., IE2). For example, an IE (e.g., IE2) may be reported when a P-MPR value in another IE (e.g., IE1) is larger than a threshold. Otherwise, the IE (e.g., IE2) for a CC may not be reported. Also, if a P bit in another IE (e.g., IE1) indicates a certain value (e.g., a value of 1), the IE (e.g., IE2) may be reported, otherwise the IE may not be reported.

In some aspects, in PHR MAC-CE reporting for a CC with a detected MPE, an IE (e.g., IE2) may be reported with at least one octet or a first octet. The octet may indicate whether and how P-MPR values/resource indexes are reported. Also, an IE (e.g., IE2) may be reported fully with a number of P-MPR values and resource indexes, e.g., N P-MPR values and resource indexes. For some instances, the number of reported P-MPR values/resource indexes may be less than a configured number, e.g., N.

Additionally, for MPE mitigation, aspects of the present disclosure may support UEs to indicate in a PHR MAC-CE for a CC based on a selection rule for one or more reported candidate beams. That is, aspects of the present disclosure may select at least one candidate beam for a transmission of a MAC-CE, and transmit an indication of the at least one candidate beam. In some aspects, the at least one candidate beam may be selected based on at least one metric. For example, the at least one metric may include an uplink reference signal received power (RSRP) value, i.e., a first layer (L1)-RSRP (L1-RSRP) value minus a P-MPR value for each resource. The at least one metric may also include a virtual PHR for each resource considering the virtual P-MPR of each resource. Further, the at least one candidate beam may be selected based on the L1-RSRP value for each resource among candidate resources, e.g., resources with P-MPR values less than a predetermined threshold. The threshold may be based on a reported metric in an IE (e.g., IE1). The threshold may also be based on a preconfigured value. Moreover, the UE may determine to select the reported resource indexes.

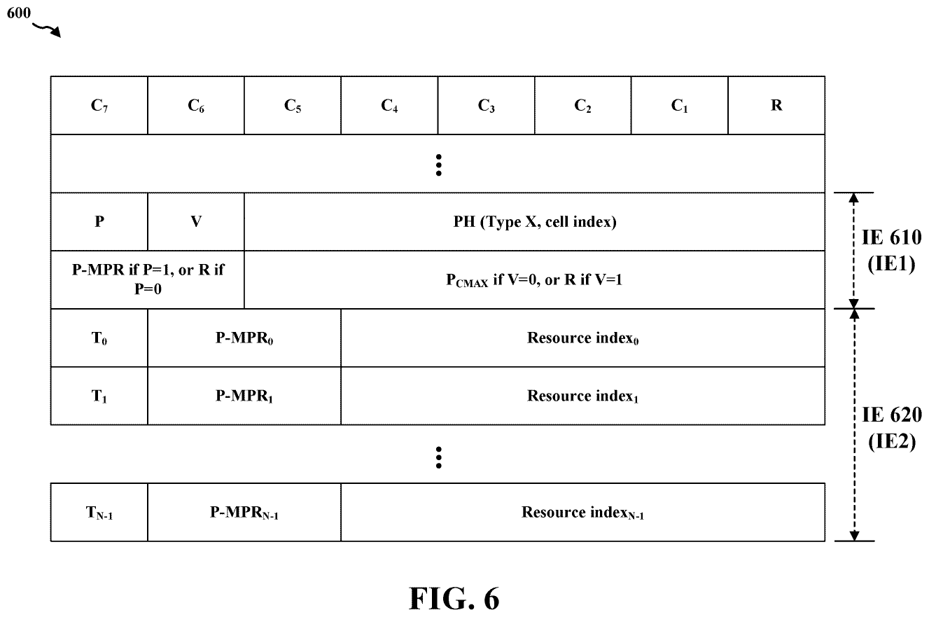

FIG. 6 is a diagram 600 illustrating an example MAC-CE. As shown in FIG. 6, diagram 600 includes eight (8) entries in each row of the MAC-CE, where each row may be referred to as an octet (Oct). Also, in FIG. 6, each bit in the first row (Oct) of the MAC-CE may correspond to a serving cell index. As shown in the MAC-CE in FIG. 6, C₀ to C₇ are in the first octet (Oct), where the C₀ bit corresponds to a reserved bit ‘R’. In one octet, the MAC-CE in FIG. 6 includes an entry for a P field, a V field, and a PH field (type X, cell index) in one octet, e.g., the P field is 1 bit, the V field is 1 bit, and the PH field is 6 bits. Further, in another octet, the MAC-CE in FIG. 6 includes a P-MPR field of 2 bits if P=1 or an R field of 2 bits if P=0. In the same octet, the MAC-CE in FIG. 6 includes a P_{CMAX} field of 6 bits if V=0 or an R field of 6 bits if V=1. As shown in FIG. 6, these two octets may be included in IE 610 (e.g., IE1). In the lower octets, the MAC-CE in FIG. 6 includes multiple T fields of 1 bit (e.g., T₀ to T_{N-1}), multiple P-MPR fields of 2 bits (e.g., P-MPR₀ to P-MPR_{N-1}), and multiple resource index fields of 5 bits (e.g., resource index₀ to resource index_{N-1}). As shown in FIG. 6, these octets may be included in IE 620 (e.g., IE2). The resource index fields may correspond to a bitmap or local index.

As depicted in FIG. 6, in some aspects, for IE reporting (e.g., IE2 reporting), IE2 may be present if the P bit is set to a value of ‘1’ in IE1. Otherwise, IE2 may not be reported. Further, for IE reporting (e.g., IE2 reporting), IE2 may be reported with a certain number of P-MPR values or resource indexes, e.g., N P-MPR values or resource indexes. Moreover, a certain T field, e.g., field Tₙ, may indicate whether certain P-MPR fields and resource index fields (e.g., P-MPR field n and/or resource index field n) are reported or reserved.

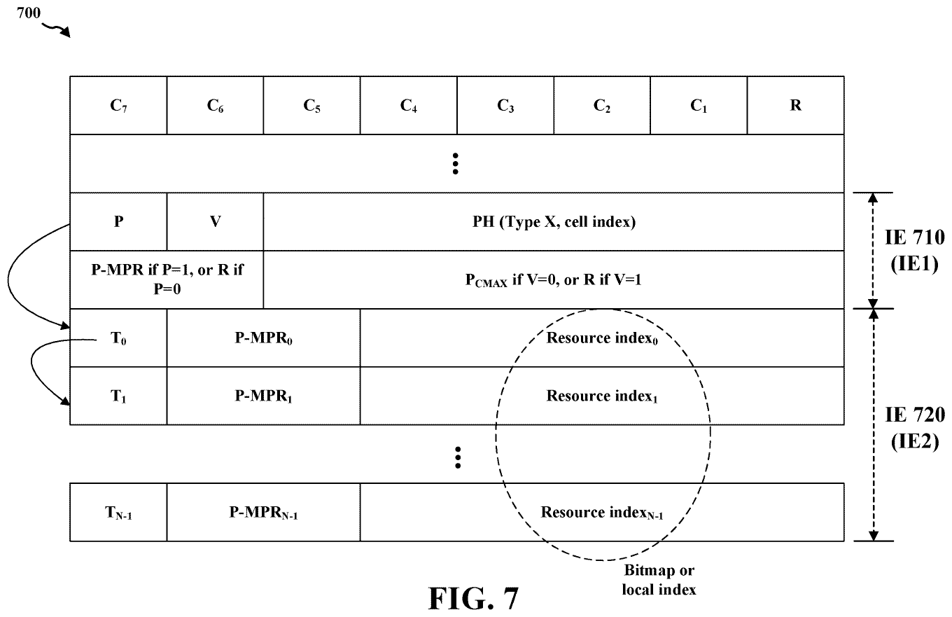

FIG. 7 is a diagram 700 illustrating another example MAC-CE. As shown in FIG. 7, diagram 700 includes eight (8) entries in each row of the MAC-CE, where each row may be referred to as an octet (Oct). Also, in FIG. 7, each bit in the first row (Oct) of the MAC-CE may correspond to a serving cell index. As shown in the MAC-CE in FIG. 7, C₀ to C₇ are in the first octet (Oct), where the C₀ bit corresponds to a reserved bit ‘R’. The MAC-CE in FIG. 7 includes an entry for a P field, a V field, and a PH field (type X, cell index) in one octet, e.g., the P field is 1 bit, the V field is 1 bit, and the PH field is 6 bits. Moreover, in another octet, the MAC-CE in FIG. 7 includes a P-MPR field of 2 bits if P=1 or an R field of 2 bits if P=0. In the same octet, the MAC-CE in FIG. 7 includes a P_{CMAX} field of 6 bits if V=0 or an R field of 6 bits if V=1. These two octets are included in IE 710 (e.g., IE1). In the lower octets, the MAC-CE in FIG. 7 includes multiple T fields of 1 bit (e.g., T₀ to T_{N-1}), multiple P-MPR fields of 2 bits (e.g., P-MPR₀ to P-MPR_{N-1}), and multiple resource index fields of 5 bits (e.g., resource index₀ to resource index_{N-1}). These octets are included in IE 720 (e.g., IE2). The resource index fields may correspond to a bitmap, a local index, or a global RS index. As shown in FIG. 7, the P field may be switched with the first T field (T₀) and/or the first T field (T₀) may be switched with the second T field (T₁).

As depicted in FIG. 7, in some aspects, a UE may report a fewer amount of P-MPR fields or resource index fields than configured. For instance, the octet with field T₀ in IE2 may exist if IE1 has indicated as much. For example, if P=1 in IE1, the octet with field T₀ in IE2 may exist if IE1 has indicated so. Also, the field Tₙ may indicate whether a next octet for fields P-MPRₙ₊₁ and resource indexₙ₊₁ are reported or not.

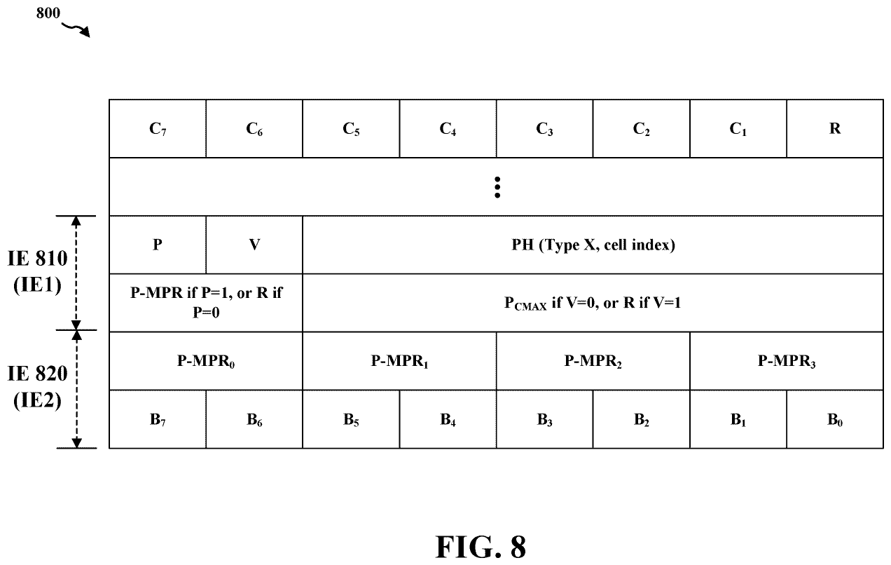

FIG. 8 is a diagram 800 illustrating an example MAC-CE. As shown in FIG. 8, diagram 800 includes eight (8) entries in each row of the MAC-CE, where each row may be referred to as an octet (Oct). Also, in FIG. 8, each bit in the first row (Oct) of the MAC-CE may correspond to a serving cell index. As shown in the MAC-CE in FIG. 8, C₀ to C₇ are in the first octet (Oct), where the C₀ bit corresponds to a reserved bit ‘R’. The MAC-CE in FIG. 8 includes an entry for a P field, a V field, and a PH field (type X, cell index) in one octet, e.g., the P field is 1 bit, the V field is 1 bit, and the PH field is 6 bits. Further, in another octet, the MAC-CE in FIG. 8 includes a P-MPR field of 2 bits if P=1 or an R field of 2 bits if P=0. In the same octet, the MAC-CE in FIG. 8 includes a P_{CMAX} field of 6 bits if V=0 or an R field of 6 bits if V=1. These two octets are included in IE 810 (e.g., IE1). Additionally, in the next octet, the MAC-CE in FIG. 8 includes four P-MPR fields of 2 bits (e.g., P-MPR₀, P-MPR₁, P-MPR₂, and P-MPR₃). In the next octet, the MAC-CE in FIG. 8 includes eight B fields of 1 bit (e.g., B₀ to B₇) in a bitmap for resource index reporting. These two octets are included in IE 820 (e.g., IE2).

As depicted in FIG. 8, in some aspects, for IE reporting (e.g., IE2 reporting), IE2 may be reduced if IE1 indicates a certain value, e.g., P-MPR is less than a threshold. Further, IE2 may contain at least an octet for P-MPR₀ through P-MPR₃. Additionally, a certain resource index, e.g., resource indexₙ, may not be reported if P-MPR, is greater than a threshold or P-MPRₙ is equal to a certain codepoint (e.g., codepoint ‘00’). In some instances, as shown in FIG. 8, P-MPR₀ to P-MPR₃ may be ordered by the reported bitmap for a resource index. For example, P-MPR₀ is the first bit set as ‘1’ in the bitmap for a resource index, P-MPR₁ is the second bit set as ‘1’ in the bitmap for a resource index, etc.

Aspects of the present disclosure may include a number of benefits or advantages. For instance, aspects of the present disclosure may more efficiently utilize PHR reporting, such as reporting via a PHR MAC-CE. Aspects of the present disclosure may reduce the amount of unnecessary IEs, e.g., determine whether multiple IEs (a first IE (IE1) and a second IE (IE2)) are reported in PHR reporting. Also, aspects of the present disclosure may efficiently select a resource to be reported in PHR reporting. Further, aspects of the present disclosure may efficiently report a resource index in PHR reporting. By doing so, aspects of the present disclosure may eliminate the amount of unnecessary space utilized in PHR reporting.

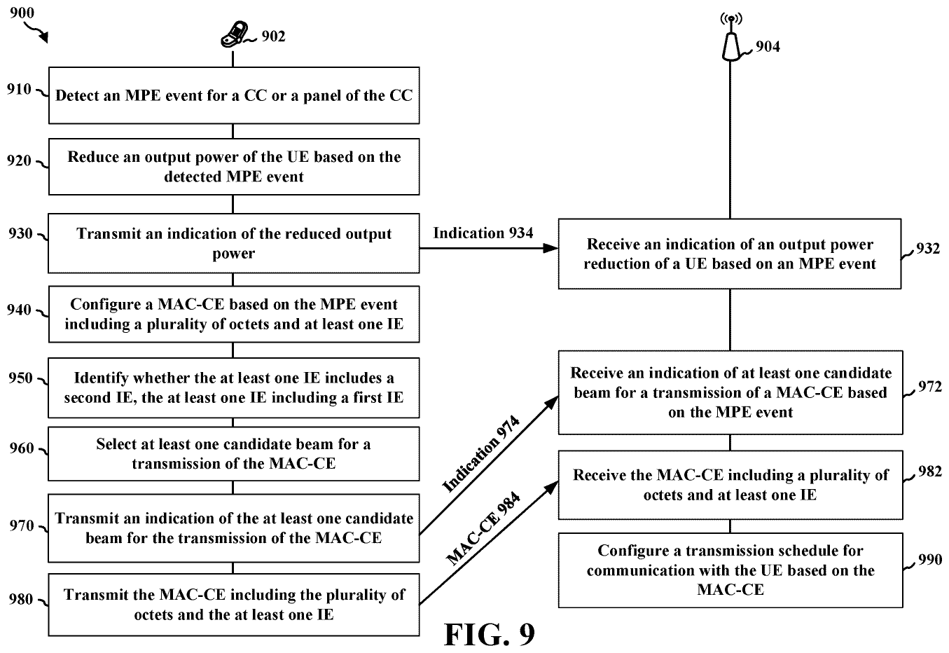

FIG. 9 is a diagram 900 illustrating example communication between a UE 902 and a base station 904.

At 910, UE 902 may detect a maximum permissible exposure (MPE) event for at least one component carrier (CC) or at least one panel of the at least one CC.

At 920, UE 902 may reduce an output power of the UE based on the detected MPE event for the at least one CC or the at least one panel of the at least one CC.

At 930, UE 902 may transmit, to the base station 904, an indication of the reduced output power of the UE based on the detected MPE event (e.g., indication 934). At 932, base station 904 may receive, from UE 902, an indication of an output power reduction of the UE based on an MPE event (e.g., indication 934).

At 940, UE 902 may configure a medium access control (MAC) control element (MAC-CE) based on the MPE event, the MAC-CE including a plurality of octets and at least one information element (IE), such that each of the at least one IE includes at least one of the plurality of octets. The MAC-CE may be a power headroom report (PHR) MAC-CE including at least one power management maximum output power reduction (P-MPR) value.

In some aspects, the MAC-CE may include one or more of at least one resource index or at least one field. The at least one resource index may be a local index associated with a candidate synchronization signal block (SSB) or a channel state information reference signal (CSI-RS) resource pool. The at least one resource index may correspond to at least one bit in a bitmap associated with a candidate synchronization signal block (SSB) or a channel state information reference signal (CSI-RS) resource pool. The at least one resource index may be a global index associated with a candidate synchronization signal block (SSB) resource indicator (SSBRI) or a channel state information reference signal (CSI-RS) resource indicator (CRI). Also, the at least one IE may include a first IE and a second IE. The first IE may include the at least one field including one or more of: a power headroom (PH) value, a power backoff (P) value, a real transmission or a reference format (V) value, a power management maximum output power reduction (P-MPR) value, or a nominal UE transmit power level (Pcmax) value. The second IE may include the at least one resource index and one or more power management maximum output power reduction (P-MPR) values.

At 950, UE 902 may identify whether the at least one IE includes a second IE, where the at least one IE includes a first IE. The at least one IE may include the second IE if the first IE indicates the second IE. The at least one IE may include the second IE if at least one octet of the plurality of octets indicates the second IE. Also, the at least one IE may include the second IE, where the second IE may include at least one power management maximum output power reduction (P-MPR) value and at least one resource index.

At 960, UE 902 may select at least one candidate beam for a transmission of the MAC-CE. The at least one candidate beam may be selected based on at least one metric including: an uplink reference signal received power (RSRP) value, a first layer (L1)-RSRP value, a virtual power headroom report (PHR), or a power management maximum output power reduction (P-MPR) value. Also, the at least one candidate beam may be selected based on a first layer (L1)-reference signal received power (RSRP) (L1-RSRP) value for a plurality of candidate resources, where each of the plurality of candidate resources includes a power management maximum output power reduction (P-MPR) value that is less than a threshold. Further, the at least one candidate beam may be selected based on at least one resource index.

At 970, UE 902 may transmit, to the base station 904, an indication of the at least one candidate beam for the transmission of the MAC-CE (e.g., indication 974). At 972, base station 904 may receive, from the UE 902, an indication of at least one candidate beam for a transmission of a MAC-CE based on an MPE event (e.g., indication 974).

At 980, UE 902 may transmit, to base station 904, the MAC-CE including the plurality of octets and the at least one IE (e.g., MAC-CE 984). At 982, base station 904 may receive, from UE 902, a MAC-CE (e.g., MAC-CE 984) including a plurality of octets and at least one information element (IE), the MAC-CE being based on a maximum permissible exposure (MPE) event for at least one component carrier (CC) or at least one panel of the at least one CC.

At 990, base station 904 may configure a transmission schedule for communication with the UE based on the MAC-CE.

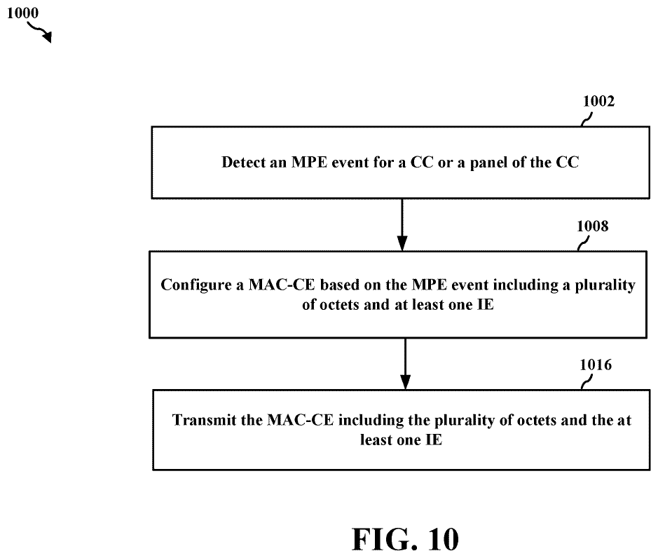

FIG. 10 is a flowchart 1000 of a method of wireless communication. The method may be performed by a UE or a component of a UE (e.g., the UE 104, 350, 402, 422, 452, 902; the apparatus 1402). The methods described herein may provide a number of benefits, such as improving communication signaling, resource utilization, and/or power savings.

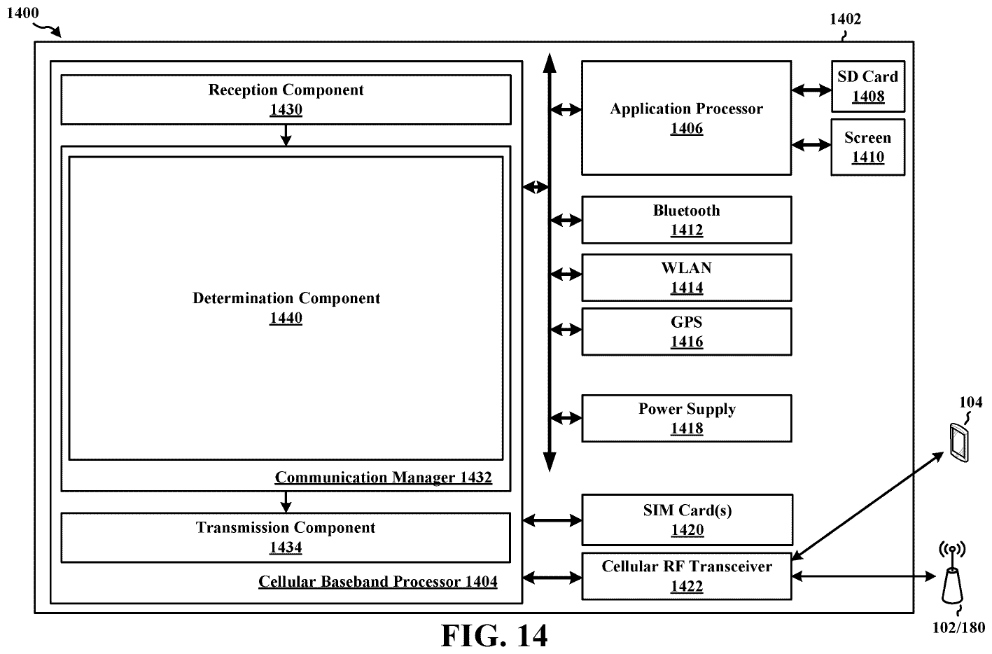

At 1002, the UE may detect a maximum permissible exposure (MPE) event for at least one component carrier (CC) or at least one panel of the at least one CC, as described in connection with the examples in FIGS. 4-9. For example, UE 902 may detect a maximum permissible exposure (MPE) event for at least one component carrier (CC) or at least one panel of the at least one CC, as described in connection with 910 in FIG. 9. Further, 1002 may be performed by determination component 1440 in FIG. 14.

At 1008, the UE may configure a medium access control (MAC) control element (MAC-CE) based on the MPE event, the MAC-CE including a plurality of octets and at least one information element (IE), such that each of the at least one IE includes at least one of the plurality of octets, as described in connection with the examples in FIGS. 4-9. For example, UE 902 may configure a medium access control (MAC) control element (MAC-CE) based on the MPE event, the MAC-CE including a plurality of octets and at least one information element (IE), such that each of the at least one IE includes at least one of the plurality of octets, as described in connection with 940 in FIG. 9. Further, 1008 may be performed by determination component 1440 in FIG. 14. The MAC-CE may be a power headroom report (PHR) MAC-CE including at least one power management maximum output power reduction (P-MPR) value.

In some aspects, the MAC-CE may include one or more of at least one resource index or at least one field. The at least one resource index may be a local index associated with a candidate synchronization signal block (SSB) or a channel state information reference signal (CSI-RS) resource pool. The at least one resource index may correspond to at least one bit in a bitmap associated with a candidate synchronization signal block (SSB) or a channel state information reference signal (CSI-RS) resource pool. The at least one resource index may be a global index associated with a candidate synchronization signal block (SSB) resource indicator (SSBRI) or a channel state information reference signal (CSI-RS) resource indicator (CRI). Also, the at least one IE may include a first IE and a second IE. The first IE may include the at least one field including one or more of: a power headroom (PH) value, a power backoff (P) value, a real transmission or a reference format (V) value, a power management maximum output power reduction (P-MPR) value, or a nominal UE transmit power level (Pcmax) value. The second IE may include the at least one resource index and one or more power management maximum output power reduction (P-MPR) values.

At 1016, the UE may transmit, to a base station, the MAC-CE including the plurality of octets and the at least one IE, as described in connection with the examples in FIGS. 4-9. For example, UE 902 may transmit, to a base station, the MAC-CE including the plurality of octets and the at least one IE, as described in connection with 980 in FIG. 9. Further, 1016 may be performed by determination component 1440 in FIG. 14.

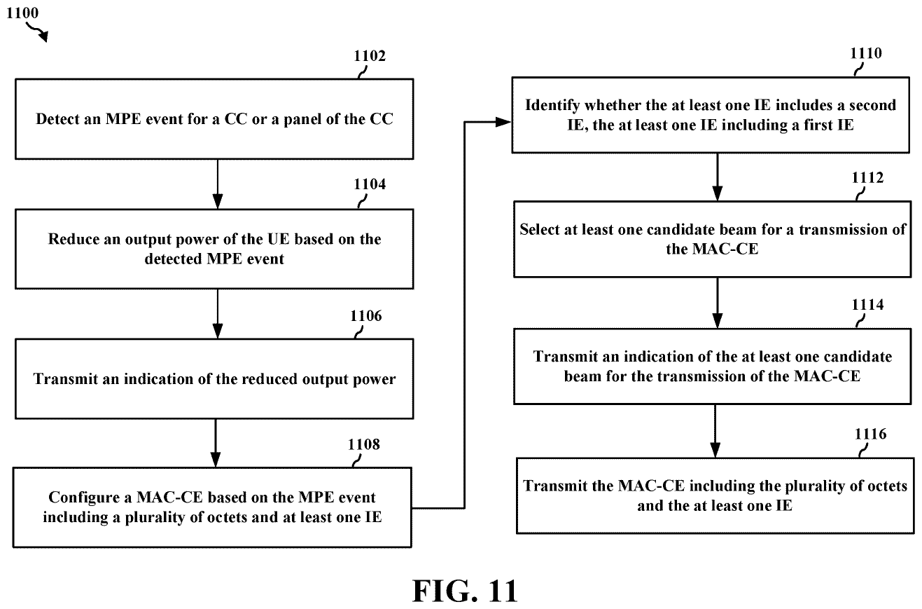

FIG. 11 is a flowchart 1100 of a method of wireless communication. The method may be performed by a UE or a component of a UE (e.g., the UE 104, 350, 402, 422, 452, 902; the apparatus 1402). The methods described herein may provide a number of benefits, such as improving communication signaling, resource utilization, and/or power savings.

At 1102, the UE may detect a maximum permissible exposure (MPE) event for at least one component carrier (CC) or at least one panel of the at least one CC, as described in connection with the examples in FIGS. 4-9. For example, UE 902 may detect a maximum permissible exposure (MPE) event for at least one component carrier (CC) or at least one panel of the at least one CC, as described in connection with 910 in FIG. 9. Further, 1102 may be performed by determination component 1440 in FIG. 14.

At 1104, the UE may reduce an output power of the UE based on the detected MPE event for the at least one CC or the at least one panel of the at least one CC, as described in connection with the examples in FIGS. 4-9. For example, UE 902 may reduce an output power of the UE based on the detected MPE event for the at least one CC or the at least one panel of the at least one CC, as described in connection with 920 in FIG. 9. Further, 1104 may be performed by determination component 1440 in FIG. 14.

At 1106, the UE may transmit, to the base station, an indication of the reduced output power of the UE based on the detected MPE event, as described in connection with the examples in FIGS. 4-9. For example, UE 902 may transmit, to the base station, an indication of the reduced output power of the UE based on the detected MPE event, as described in connection with 930 in FIG. 9. Further, 1106 may be performed by determination component 1440 in FIG. 14.

At 1108, the UE may configure a medium access control (MAC) control element (MAC-CE) based on the MPE event, the MAC-CE including a plurality of octets and at least one information element (IE), such that each of the at least one IE includes at least one of the plurality of octets, as described in connection with the examples in FIGS. 4-9. For example, UE 902 may configure a medium access control (MAC) control element (MAC-CE) based on the MPE event, the MAC-CE including a plurality of octets and at least one information element (IE), such that each of the at least one IE includes at least one of the plurality of octets, as described in connection with 940 in FIG. 9. Further, 1108 may be performed by determination component 1440 in FIG. 14. The MAC-CE may be a power headroom report (PHR) MAC-CE including at least one power management maximum output power reduction (P-MPR) value.

In some aspects, the MAC-CE may include one or more of at least one resource index or at least one field. The at least one resource index may be a local index associated with a candidate synchronization signal block (SSB) or a channel state information reference signal (CSI-RS) resource pool. The at least one resource index may correspond to at least one bit in a bitmap associated with a candidate synchronization signal block (SSB) or a channel state information reference signal (CSI-RS) resource pool. The at least one resource index may be a global index associated with a candidate synchronization signal block (SSB) resource indicator (SSBRI) or a channel state information reference signal (CSI-RS) resource indicator (CRI). Also, the at least one IE may include a first IE and a second IE. The first IE may include the at least one field including one or more of: a power headroom (PH) value, a power backoff (P) value, a real transmission or a reference format (V) value, a power management maximum output power reduction (P-MPR) value, or a nominal UE transmit power level (Pcmax) value. The second IE may include the at least one resource index and one or more power management maximum output power reduction (P-MPR) values.

At 1110, the UE may identify whether the at least one IE includes a second IE, where the at least one IE includes a first IE, as described in connection with the examples in FIGS. 4-9. For example, UE 902 may identify whether the at least one IE includes a second IE, where the at least one IE includes a first IE, as described in connection with 950 in FIG. 9. Further, 1110 may be performed by determination component 1440 in FIG. 14. The at least one IE may include the second IE if the first IE indicates the second IE. The at least one IE may include the second IE if at least one octet of the plurality of octets indicates the second IE. Also, the at least one IE may include the second IE, where the second IE may include at least one power management maximum output power reduction (P-MPR) value and at least one resource index.

At 1112, the UE may select at least one candidate beam for a transmission of the MAC-CE, as described in connection with the examples in FIGS. 4-9. For example, UE 902 may select at least one candidate beam for a transmission of the MAC-CE, as described in connection with 960 in FIG. 9. Further, 1112 may be performed by determination component 1440 in FIG. 14. The at least one candidate beam may be selected based on at least one metric including: an uplink reference signal received power (RSRP) value, a first layer (L1)-RSRP value, a virtual power headroom report (PHR), or a power management maximum output power reduction (P-MPR) value. Also, the at least one candidate beam may be selected based on a first layer (L1)-reference signal received power (RSRP) (L1-RSRP) value for a plurality of candidate resources, where each of the plurality of candidate resources includes a power management maximum output power reduction (P-MPR) value that is less than a threshold. Further, the at least one candidate beam may be selected based on at least one resource index.

At 1114, the UE may transmit, to a base station, an indication of the at least one candidate beam for the transmission of the MAC-CE, as described in connection with the examples in FIGS. 4-9. For example, UE 902 may transmit, to a base station, an indication of the at least one candidate beam for the transmission of the MAC-CE, as described in connection with 970 in FIG. 9. Further, 1114 may be performed by determination component 1440 in FIG. 14.

At 1116, the UE may transmit, to a base station, the MAC-CE including the plurality of octets and the at least one IE, as described in connection with the examples in FIGS. 4-9. For example, UE 902 may transmit, to a base station, the MAC-CE including the plurality of octets and the at least one IE, as described in connection with 980 in FIG. 9. Further, 1116 may be performed by determination component 1440 in FIG. 14.

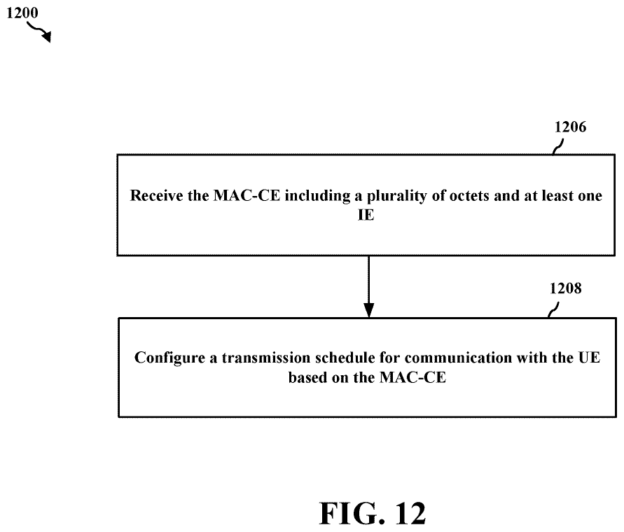

FIG. 12 is a flowchart 1200 of a method of wireless communication. The method may be performed by a base station or a component of a base station (e.g., the base station 102, 180, 310, 404, 424, 454, 904; the apparatus 1502). The methods described herein may provide a number of benefits, such as improving communication signaling, resource utilization, and/or power savings.

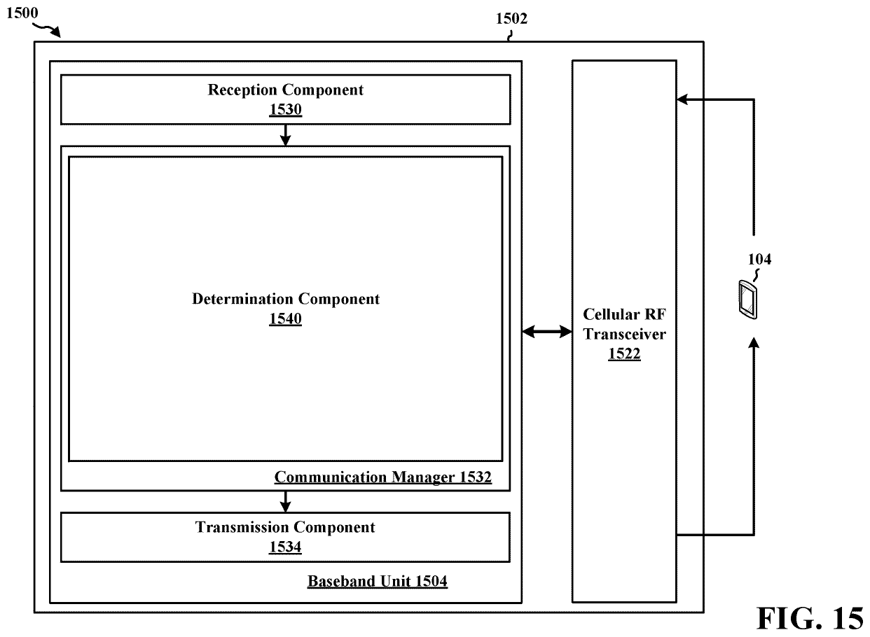

At 1206, the base station may receive, from a UE, a MAC-CE including a plurality of octets and at least one information element (IE), the MAC-CE being based on a maximum permissible exposure (MPE) event for at least one component carrier (CC) or at least one panel of the at least one CC, as described in connection with the examples in FIGS. 4-9. For example, base station 904 may receive, from a UE, a MAC-CE including a plurality of octets and at least one information element (IE), the MAC-CE being based on a maximum permissible exposure (MPE) event for at least one component carrier (CC) or at least one panel of the at least one CC, as described in connection with 982 in FIG. 9. Further, 1206 may be performed by determination component 1540 in FIG. 15. The MAC-CE may be a power headroom report (PHR) MAC-CE including at least one power management maximum output power reduction (P-MPR) value.

In some aspects, the MAC-CE may include one or more of at least one resource index or at least one field. The at least one resource index may be a local index associated with a candidate synchronization signal block (SSB) or a channel state information reference signal (CSI-RS) resource pool. The at least one resource index may correspond to at least one bit in a bitmap associated with a candidate synchronization signal block (SSB) or a channel state information reference signal (CSI-RS) resource pool. The at least one resource index may be a global index associated with a candidate synchronization signal block (SSB) resource indicator (SSBRI) or a channel state information reference signal (CSI-RS) resource indicator (CRI). Also, the at least one IE may include a first IE and a second IE. The first IE may include the at least one field including one or more of: a power headroom (PH) value, a power backoff (P) value, a real transmission or a reference format (V) value, a power management maximum output power reduction (P-MPR) value, or a nominal UE transmit power level (Pcmax) value. The second IE may include the at least one resource index and one or more power management maximum output power reduction (P-MPR) values.

Additionally, the at least one IE may include a first IE. The at least one IE may include the second IE if the first IE indicates the second IE. The at least one IE may include the second IE if at least one octet of the plurality of octets indicates the second IE. Also, the at least one IE may include the second IE, where the second IE may include at least one power management maximum output power reduction (P-MPR) value and at least one resource index.

At 1208, the base station may configure a transmission schedule for communication with the UE based on the MAC-CE, as described in connection with the examples in FIGS. 4-9. For example, base station 904 may configure a transmission schedule for communication with the UE based on the MAC-CE, as described in connection with 990 in FIG. 9. Further, 1208 may be performed by determination component 1540 in FIG. 15.

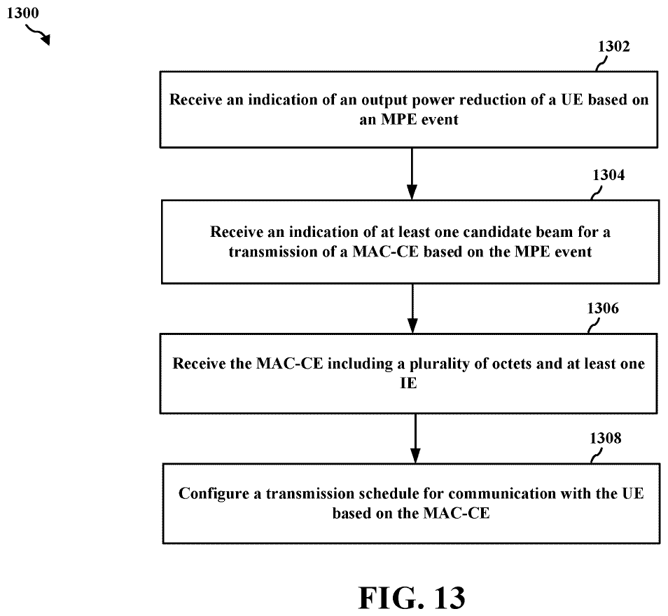

FIG. 13 is a flowchart 1300 of a method of wireless communication. The method may be performed by a base station or a component of a base station (e.g., the base station 102, 180, 310, 404, 424, 454, 904; the apparatus 1502). The methods described herein may provide a number of benefits, such as improving communication signaling, resource utilization, and/or power savings.

At 1302, the base station may receive, from a UE, an indication of an output power reduction of the UE based on an MPE event, as described in connection with the examples in FIGS. 4-9. For example, base station 904 may, as described in connection with 932 in FIG. 9. Further, 1302 may be performed by determination component 1540 in FIG. 15.

At 1304, the base station may receive, from the UE, an indication of at least one candidate beam for a transmission of a MAC-CE based on an MPE event, as described in connection with the examples in FIGS. 4-9. For example, base station 904 may receive, from the UE, an indication of at least one candidate beam for a transmission of a MAC-CE based on an MPE event, as described in connection with 972 in FIG. 9. Further, 1304 may be performed by determination component 1540 in FIG. 15.

The at least one candidate beam may be based on at least one metric including: an uplink reference signal received power (RSRP) value, a first layer (L1)-RSRP value, a virtual power headroom report (PHR), or a power management maximum output power reduction (P-MPR) value. Also, the at least one candidate beam may be based on a first layer (L1)-reference signal received power (RSRP) (L1-RSRP) value for a plurality of candidate resources, where each of the plurality of candidate resources includes a power management maximum output power reduction (P-MPR) value that is less than a threshold. Further, the at least one candidate beam may be based on at least one resource index.

At 1306, the base station may receive, from a UE, a MAC-CE including a plurality of octets and at least one information element (IE), the MAC-CE being based on a maximum permissible exposure (MPE) event for at least one component carrier (CC) or at least one panel of the at least one CC, as described in connection with the examples in FIGS. 4-9. For example, base station 904 may receive, from a UE, a MAC-CE including a plurality of octets and at least one information element (IE), the MAC-CE being based on a maximum permissible exposure (MPE) event for at least one component carrier (CC) or at least one panel of the at least one CC, as described in connection with 982 in FIG. 9. Further, 1306 may be performed by determination component 1540 in FIG. 15. The MAC-CE may be a power headroom report (PHR) MAC-CE including at least one power management maximum output power reduction (P-MPR) value.

In some aspects, the MAC-CE may include one or more of at least one resource index or at least one field. The at least one resource index may be a local index associated with a candidate synchronization signal block (SSB) or a channel state information reference signal (CSI-RS) resource pool. The at least one resource index may correspond to at least one bit in a bitmap associated with a candidate synchronization signal block (SSB) or a channel state information reference signal (CSI-RS) resource pool. The at least one resource index may be a global index associated with a candidate synchronization signal block (SSB) resource indicator (SSBRI) or a channel state information reference signal (CSI-RS) resource indicator (CRI). Also, the at least one IE may include a first IE and a second IE. The first IE may include the at least one field including one or more of: a power headroom (PH) value, a power backoff (P) value, a real transmission or a reference format (V) value, a power management maximum output power reduction (P-MPR) value, or a nominal UE transmit power level (Pcmax) value. The second IE may include the at least one resource index and one or more power management maximum output power reduction (P-MPR) values.

Additionally, the at least one IE may include a first IE. The at least one IE may include the second IE if the first IE indicates the second IE. The at least one IE may include the second IE if at least one octet of the plurality of octets indicates the second IE. Also, the at least one IE may include the second IE, where the second IE may include at least one power management maximum output power reduction (P-MPR) value and at least one resource index.

At 1308, the base station may configure a transmission schedule for communication with the UE based on the MAC-CE, as described in connection with the examples in FIGS. 4-9. For example, base station 904 may configure a transmission schedule for communication with the UE based on the MAC-CE, as described in connection with 990 in FIG. 9. Further, 1308 may be performed by determination component 1540 in FIG. 15.

FIG. 14 is a diagram 1400 illustrating an example of a hardware implementation for an apparatus 1402. The apparatus 1402 may be a UE, a component of a UE, or may implement UE functionality. In some aspects, the apparatus 1402 may include a cellular baseband processor 1404 (also referred to as a modem) coupled to a cellular RF transceiver 1422. In some aspects, the apparatus 1402 may further include one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, or a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 350 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see 350 of FIG. 3) and include the additional modules of the apparatus 1402.

The communication manager 1432 includes a determination component 1440 that is configured to detect a maximum permissible exposure (MPE) event for at least one component carrier (CC) or at least one panel of the at least one CC, e.g., as described in connection with step 1102 above. Determination component 1440 may also be configured to reduce an output power of the UE based on the detected MPE event for the at least one CC or the at least one panel of the at least one CC, e.g., as described in connection with step 1104 above. Determination component 1440 may also be configured to transmit, to the base station, an indication of the reduced output power of the UE based on the detected MPE event, e.g., as described in connection with step 1106 above. Determination component 1440 may also be configured to configure a medium access control (MAC) control element (MAC-CE) based on the MPE event, the MAC-CE including a plurality of octets and at least one information element (IE), such that each of the at least one IE includes at least one of the plurality of octets, e.g., as described in connection with step 1108 above. Determination component 1440 may also be configured to identify whether the at least one IE includes a second IE, where the at least one IE includes a first IE, e.g., as described in connection with step 1110 above. Determination component 1440 may also be configured to select at least one candidate beam for a transmission of the MAC-CE, e.g., as described in connection with step 1112 above. Determination component 1440 may also be configured to transmit, to the base station, an indication of the at least one candidate beam for the transmission of the MAC-CE, e.g., as described in connection with step 1114 above. Determination component 1440 may also be configured to transmit, to a base station, the MAC-CE including the plurality of octets and the at least one IE, e.g., as described in connection with step 1116 above.

The apparatus may include additional components that perform each of the blocks of the algorithm in the flowcharts of FIGS. 9-11. As such, each block in the flowcharts of FIGS. 9-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the cellular baseband processor 1404, includes means for detecting a maximum permissible exposure (MPE) event for at least one component carrier (CC) or at least one panel of the at least one CC; means for reducing an output power of the UE based on the detected MPE event for the at least one CC or the at least one panel of the at least one CC; means for transmitting, to the base station, an indication of the reduced output power of the UE based on the detected MPE event; means for configuring a medium access control (MAC) control element (MAC-CE) based on the MPE event, the MAC-CE including a plurality of octets and at least one information element (IE), such that each of the at least one IE includes at least one of the plurality of octets; means for identifying whether the at least one IE includes a second IE, where the at least one IE includes a first IE; means for selecting at least one candidate beam for a transmission of the MAC-CE; means for transmitting, to the base station, an indication of the at least one candidate beam for the transmission of the MAC-CE; and means for transmitting, to a base station, the MAC-CE including the plurality of octets and the at least one IE. The means may be one or more of the components of the apparatus 1402 configured to perform the functions recited by the means. As described supra, the apparatus 1402 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 15 is a diagram 1500 illustrating an example of a hardware implementation for an apparatus 1502. The apparatus 1502 may be a base station, a component of a base station, or may implement base station functionality. In some aspects, the apparatus 1502 may include a baseband unit 1504. The baseband unit 1504 may communicate through a cellular RF transceiver 1522 with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the base station 310 and may include the memory 376 and/or at least one of the TX processor 316, the RX processor 370, and the controller/processor 375.

The communication manager 1532 includes a determination component 1540 that is configured to receive, from a UE, an indication of an output power reduction of the UE based on the MPE event, e.g., as described in connection with step 1302 above. Determination component 1540 may also be configured to receive, from the UE, an indication of at least one candidate beam for a transmission of the MAC-CE, e.g., as described in connection with step 1304 above. Determination component 1540 may also be configured to receive, from a user equipment (UE), a medium access control (MAC) control element (MAC-CE) including a plurality of octets and at least one information element (IE), the MAC-CE being based on a maximum permissible exposure (MPE) event for at least one component carrier (CC) or at least one panel of the at least one CC, e.g., as described in connection with step 1306 above. Determination component 1540 may also be configured to configure a transmission schedule for communication with the UE based on the MAC-CE, e.g., as described in connection with step 1308 above.

The apparatus may include additional components that perform each of the blocks of the algorithm in the flowcharts of FIGS. 9, 12, and 13. As such, each block in the flowcharts of FIGS. 9, 12, and 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the baseband unit 1504, includes means for receiving, from a UE, an indication of an output power reduction of the UE based on the MPE event; means for receiving, from the UE, an indication of at least one candidate beam for a transmission of the MAC-CE; means for receiving, from a user equipment (UE), a medium access control (MAC) control element (MAC-CE) including a plurality of octets and at least one information element (IE), the MAC-CE being based on a maximum permissible exposure (MPE) event for at least one component carrier (CC) or at least one panel of the at least one CC; and means for configuring a transmission schedule for communication with the UE based on the MAC-CE. The means may be one or more of the components of the apparatus 1502 configured to perform the functions recited by the means. As described supra, the apparatus 1502 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if”, “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to: detect a maximum permissible exposure (MPE) event for at least one component carrier (CC) or at least one panel of the at least one CC; configure a medium access control (MAC) control element (MAC-CE) based on the MPE event, the MAC-CE including a plurality of octets and at least one information element (IE), such that each of the at least one IE includes at least one of the plurality of octets; and transmit, to a base station, the MAC-CE including the plurality of octets and the at least one IE.

Aspect 2 is the apparatus of aspect 1, where the at least one processor is further configured to: reduce an output power of the UE based on the detected MPE event for the at least one CC or the at least one panel of the at least one CC.

Aspect 3 is the apparatus of any of aspects 1 and 2, where the at least one processor is further configured to: transmit, to the base station, an indication of the reduced output power of the UE based on the detected MPE event.

Aspect 4 is the apparatus of any of aspects 1 to 3, where the MAC-CE includes one or more of at least one resource index or at least one field.

Aspect 5 is the apparatus of any of aspects 1 to 4, where the at least one resource index is a local index associated with a candidate synchronization signal block (SSB) or a channel state information reference signal (CSI-RS) resource pool.

Aspect 6 is the apparatus of any of aspects 1 to 5, where the at least one resource index corresponds to at least one bit in a bitmap associated with a candidate synchronization signal block (SSB) or a channel state information reference signal (CSI-RS) resource pool.

Aspect 7 is the apparatus of any of aspects 1 to 6, where the at least one resource index is a global index associated with a candidate synchronization signal block (SSB) resource indicator (SSBRI) or a channel state information reference signal (CSI-RS) resource indicator (CRI).

Aspect 8 is the apparatus of any of aspects 1 to 7, where the at least one IE includes a first IE and a second IE.

Aspect 9 is the apparatus of any of aspects 1 to 8, where the first IE includes the at least one field including one or more of: a power headroom (PH) value, a power backoff (P) value, a real transmission or a reference format (V) value, a power management maximum output power reduction (P-MPR) value, or a nominal UE transmit power level (Pcmax) value.

Aspect 10 is the apparatus of any of aspects 1 to 9, where the second IE includes the at least one resource index and one or more power management maximum output power reduction (P-MPR) values.

Aspect 11 is the apparatus of any of aspects 1 to 10, where the at least one processor is further configured to: identify whether the at least one IE includes a second IE, where the at least one IE includes a first IE.

Aspect 12 is the apparatus of any of aspects 1 to 11, where the at least one IE includes the second IE if the first IE indicates the second IE.

Aspect 13 is the apparatus of any of aspects 1 to 12, where the at least one IE includes the second IE if at least one octet of the plurality of octets indicates the second IE.

Aspect 14 is the apparatus of any of aspects 1 to 13, where the at least one IE includes the second IE, where the second IE includes at least one power management maximum output power reduction (P-MPR) value and at least one resource index.

Aspect 15 is the apparatus of any of aspects 1 to 14, where the at least one processor is further configured to: select at least one candidate beam for a transmission of the MAC-CE; and transmit, to the base station, an indication of the at least one candidate beam for the transmission of the MAC-CE.

Aspect 16 is the apparatus of any of aspects 1 to 15, where the at least one candidate beam is selected based on at least one metric including: an uplink reference signal received power (RSRP) value, a first layer (L1)-RSRP value, a virtual power headroom report (PHR), or a power management maximum output power reduction (P-MPR) value.

Aspect 17 is the apparatus of any of aspects 1 to 16, where the at least one candidate beam is selected based on a first layer (L1)-reference signal received power (RSRP) (L1-RSRP) value for a plurality of candidate resources, where each of the plurality of candidate resources includes a power management maximum output power reduction (P-MPR) value that is less than a threshold.

Aspect 18 is the apparatus of any of aspects 1 to 17, where the at least one candidate beam is selected based on at least one resource index.

Aspect 19 is the apparatus of any of aspects 1 to 18, where the MAC-CE is a power headroom report (PHR) MAC-CE including at least one power management maximum output power reduction (P-MPR) value.

Aspect 20 is the apparatus of any of aspects 1 to 20, further including a transceiver or an antenna coupled to the at least one processor.

Aspect 21 is a method of wireless communication for implementing any of aspects 1 to 20.

Aspect 22 is an apparatus for wireless communication including means for implementing any of aspects 1 to 20.

Aspect 23 is a computer-readable medium storing computer executable code, where the code when executed by a processor causes the processor to implement any of aspects 1 to 20.

Aspect 24 is an apparatus for wireless communication at a base station including at least one processor coupled to a memory and configured to: receive, from a user equipment (UE), a medium access control (MAC) control element (MAC-CE) including a plurality of octets and at least one information element (IE), the MAC-CE being based on a maximum permissible exposure (MPE) event for at least one component carrier (CC) or at least one panel of the at least one CC; and configure a transmission schedule for communication with the UE based on the MAC-CE.

Aspect 25 is the apparatus of aspect 24, where the at least one processor is further configured to: receive, from the UE, an indication of an output power reduction of the UE based on the MPE event.

Aspect 26 is the apparatus of any of aspects 24 and 25, where the MAC-CE includes one or more of at least one resource index or at least one field.

Aspect 27 is the apparatus of any of aspects 24 to 26, where the at least one resource index is a local index associated with a candidate synchronization signal block (SSB) or a channel state information reference signal (CSI-RS) resource pool, the at least one resource index corresponds to at least one bit in a bitmap associated with the candidate SSB or the CSI-RS resource pool, or the at least one resource index is a global index associated with a candidate SSB resource indicator (SSBRI) or a CSI-RS resource indicator (CRI).

Aspect 28 is the apparatus of any of aspects 24 to 27, where the at least one IE includes a first IE and a second IE; and where the first IE includes the at least one field including one or more of: a power headroom (PH) value, a power backoff (P) value, a real transmission or a reference format (V) value, a power management maximum output power reduction (P-MPR) value, or a nominal UE transmit power level (Pcmax) value, or the second IE includes the at least one resource index and one or more power management maximum output power reduction (P-MPR) values.

Aspect 29 is the apparatus of any of aspects 24 to 28, where the at least one IE includes a first IE; and where the at least one IE includes a second IE if the first IE indicates the second IE, the at least one IE includes the second IE if at least one octet of the plurality of octets indicates the second IE, or the at least one IE includes the second IE, where the second IE includes at least one power management maximum output power reduction (P-MPR) value and at least one resource index.

Aspect 30 is the apparatus of any of aspects 24 to 29, where the at least one processor is further configured to: receive, from the UE, an indication of at least one candidate beam for a transmission of the MAC-CE.

Aspect 31 is the apparatus of any of aspects 24 to 30, where the at least one candidate beam is based on at least one metric including: an uplink reference signal received power (RSRP) value, a first layer (L1)-RSRP value, a virtual power headroom report (PHR), or a power management maximum output power reduction (P-MPR) value, where the at least one candidate beam is based on an L1-RSRP value for a plurality of candidate resources, where each of the plurality of candidate resources includes a P-MPR value that is less than a threshold, or where the at least one candidate beam is based on at least one resource index.

Aspect 32 is the apparatus of any of aspects 24 to 31, where the MAC-CE is a power headroom report (PHR) MAC-CE including at least one power management maximum output power reduction (P-MPR) value.

Aspect 33 is the apparatus of any of aspects 24 to 32, further including a transceiver or an antenna coupled to the at least one processor.

Aspect 34 is a method of wireless communication for implementing any of aspects 24 to 33.

Aspect 35 is an apparatus for wireless communication including means for implementing any of aspects 24 to 33.

Aspect 36 is a computer-readable medium storing computer executable code, where the code when executed by a processor causes the processor to implement any of aspects 24 to 33.

What is claimed is:

1. An apparatus for wireless communication at a user equipment (UE), comprising:
a memory; and
at least one processor coupled to the memory and configured to:
detect a maximum permissible exposure (MPE) event for at least one component carrier (CC) or at least one panel of the at least one CC;
configure a medium access control (MAC) control element (MAC-CE) based on the MPE event, the MAC-CE including a plurality of octets and at least one information element (IE), such that each of the at least one IE includes at least one of the plurality of octets; and
transmit, to a base station, the MAC-CE including the plurality of octets and the at least one IE.

2. The apparatus of claim 1, wherein the at least one processor is further configured to:
reduce an output power of the UE based on the detected MPE event for the at least one CC or the at least one panel of the at least one CC.

3. The apparatus of claim 2, wherein the at least one processor is further configured to:
transmit, to the base station, an indication of the reduced output power of the UE based on the detected MPE event.

4. The apparatus of claim 1, wherein the MAC-CE includes one or more of at least one resource index or at least one field.

5. The apparatus of claim 4, wherein the at least one resource index is a local index associated with a candidate synchronization signal block (SSB) or a channel state information reference signal (CSI-RS) resource pool.

6. The apparatus of claim 4, wherein the at least one resource index corresponds to at least one bit in a bitmap associated with a candidate synchronization signal block (SSB) or a channel state information reference signal (CSI-RS) resource pool.

7. The apparatus of claim 4, wherein the at least one resource index is a global index associated with a candidate synchronization signal block (SSB) resource indicator (SSBRI) or a channel state information reference signal (CSI-RS) resource indicator (CRI).

8. The apparatus of claim 4, wherein the at least one IE includes a first IE and a second IE.

9. The apparatus of claim 8, wherein the first IE includes the at least one field including one or more of: a power headroom (PH) value, a power backoff (P) value, a real transmission or a reference format (V) value, a power management maximum output power reduction (P-MPR) value, or a nominal UE transmit power level (Pcmax) value.

10. The apparatus of claim 8, wherein the second IE includes the at least one resource index and one or more power management maximum output power reduction (P-MPR) values.

11. The apparatus of claim 1, wherein the at least one processor is further configured to:
identify whether the at least one IE includes a second IE, wherein the at least one IE includes a first IE.

12. The apparatus of claim 11, wherein the at least one IE includes the second IE if the first IE indicates the second IE.

13. The apparatus of claim 11, wherein the at least one IE includes the second IE if at least one octet of the plurality of octets indicates the second IE.

14. The apparatus of claim 11, wherein the at least one IE includes the second IE, wherein the second IE includes at least one power management maximum output power reduction (P-MPR) value and at least one resource index.

15. The apparatus of claim 1, wherein the at least one processor is further configured to:
select at least one candidate beam for a transmission of the MAC-CE; and
transmit, to the base station, an indication of the at least one candidate beam for the transmission of the MAC-CE.

16. The apparatus of claim 15, wherein the at least one candidate beam is selected based on at least one metric including: an uplink reference signal received power (RSRP) value, a first layer (L1)-RSRP value, a virtual power headroom report (PHR), or a power management maximum output power reduction (P-MPR) value.

17. The apparatus of claim 15, wherein the at least one candidate beam is selected based on a first layer (L1)-reference signal received power (RSRP) (L1-RSRP) value for a plurality of candidate resources, wherein each of the plurality of candidate resources includes a power management maximum output power reduction (P-MPR) value that is less than a threshold.

18. The apparatus of claim 15, wherein the at least one candidate beam is selected based on at least one resource index.

19. The apparatus of claim 1, further comprising a transceiver or an antenna coupled to the at least one processor, wherein the MAC-CE is a power headroom report (PHR) MAC-CE including at least one power management maximum output power reduction (P-MPR) value.

20. An apparatus for wireless communication at a base station, comprising:
a memory; and
at least one processor coupled to the memory and configured to:
receive, from a user equipment (UE), a medium access control (MAC) control element (MAC-CE) including a plurality of octets and at least one information element (IE), the MAC-CE being based on a maximum permissible exposure (MPE) event for at least one component carrier (CC) or at least one panel of the at least one CC; and
configure a transmission schedule for communication with the UE based on the MAC-CE.

21. The apparatus of claim 20, wherein the at least one processor is further configured to:
receive, from the UE, an indication of an output power reduction of the UE based on the MPE event.

22. The apparatus of claim 20, wherein the MAC-CE includes one or more of at least one resource index or at least one field.

23. The apparatus of claim 22, wherein the at least one resource index is a local index associated with a candidate synchronization signal block (SSB) or a channel state information reference signal (CSI-RS) resource pool,
wherein the at least one resource index corresponds to at least one bit in a bitmap associated with the candidate SSB or the CSI-RS resource pool, or
wherein the at least one resource index is a global index associated with a candidate SSB resource indicator (SSBRI) or a CSI-RS resource indicator (CRI).

24. The apparatus of claim 22, wherein the at least one IE includes a first IE and a second IE; and
wherein the first IE includes the at least one field including one or more of: a power headroom (PH) value, a power backoff (P) value, a real transmission or a reference format (V) value, a power management maximum output power reduction (P-MPR) value, or a nominal UE transmit power level (Pcmax) value, or
wherein the second IE includes the at least one resource index and one or more power management maximum output power reduction (P-MPR) values.

25. The apparatus of claim 20, wherein the at least one IE includes a first IE; and
wherein the at least one IE includes a second IE if the first IE indicates the second IE,
wherein the at least one IE includes the second IE if at least one octet of the plurality of octets indicates the second IE, or
wherein the at least one IE includes the second IE, wherein the second IE includes at least one power management maximum output power reduction (P-MPR) value and at least one resource index.

26. The apparatus of claim 20, wherein the at least one processor is further configured to:
receive, from the UE, an indication of at least one candidate beam for a transmission of the MAC-CE.

27. The apparatus of claim 26, wherein the at least one candidate beam is based on at least one metric including: an uplink reference signal received power (RSRP) value, a first layer (L1)-RSRP value, a virtual power headroom report (PHR), or a power management maximum output power reduction (P-MPR) value,
wherein the at least one candidate beam is based on an L1-RSRP value for a plurality of candidate resources, wherein each of the plurality of candidate resources includes a P-MPR value that is less than a threshold, or
wherein the at least one candidate beam is based on at least one resource index.

28. The apparatus of claim 20, further comprising a transceiver or an antenna coupled to the at least one processor, wherein the MAC-CE is a power headroom report (PHR) MAC-CE including at least one power management maximum output power reduction (P-MPR) value.

29. A method of wireless communication at a user equipment (UE), comprising:
detecting a maximum permissible exposure (MPE) event for at least one component carrier (CC) or at least one panel of the at least one CC;
configuring a medium access control (MAC) control element (MAC-CE) based on the MPE event, the MAC-CE including a plurality of octets and at least one information element (IE), such that each of the at least one IE includes at least one of the plurality of octets; and
transmitting, to a base station, the MAC-CE including the plurality of octets and the at least one IE.

30. A method of wireless communication at abase station, comprising:
receiving, from a user equipment (UE), a medium access control (MAC) control element (MAC-CE) including a plurality of octets and at least one information element (IE), the MAC-CE being based on a maximum permissible exposure (MPE) event for at least one component carrier (CC) or at least one panel of the at least one CC; and
configuring a transmission schedule for communication with the UE based on the MAC-CE.
